(19) United States
(12) Patent Application Publication
(10) Pub. No.: US 2002/0078219 A1
(43) Pub. Date: Jun. 20, 2002

(54) Communications system and method therefor

(76) Inventors: Christopher Tate, Bishops Stortford (GB); Brian Unitt, Bishops Stortford (GB)

Correspondence Address: Lee, Mann, Smith, McWilliams, Sweeney & Ohlson, PO Box 2786, Chicago, IL, 60690-2786, US

(21) Appl. No.: 09/737,050

(22) Filed: Dec. 14, 2000

(51) Int. Cl. G06F 15/16

(52) U.S. Cl. 709/231

(57) ABSTRACT

Known communications systems for providing Near Video On-Demand services require a large quantity of bandwidth in order to transfer a number of time-staggered versions of an original data stream to a set-top decoders. In order to reduce bandwidth requirements, the present invention provides a communications system (100) for providing data streaming services to a plurality of client terminator units (122) by providing a multicast server (108) capable of delivering a number of time-staggered versions of an original data stream to the plurality of client terminator units (122). (Consequently, the present invention advantageously obviates a need for a relatively large bandwidth to be provided for communications between a content providing server (102) and the multicast server (108).

### FIELD OF THE INVENTION

The present invention relates to a communications system of the type used to provide staggered versions of a data stream, for example, in connection with Near Video On-Demand (NVOD) applications. The present invention also relates to a method of distributing a data stream.

### BACKGROUND TO THE INVENTION

It is known to provide NVOD services in which content, for example media, such as a film, is repeatedly transmitted at a repeat interval of, for example, 10 to 15 minutes. Each transmission of the film talcs place over a separate channel. Consequently, a number of channels is required to respectively show multiple versions of the film, each version of the film corresponding to a respective start time, A subscriber to the NVOD service wishing to view the film simply needs to determine a next start time convenient to tie subscriber and request to view the film shortly before the next start time. The communications system then permits the subscriber to view the film on an appropriate channel corresponding to the next start time.

In one Known NVOD system, a content providing server is coupled to a communications network in order to be able to deliver an originating data stream to a number of gateways of respective home networks, the number of gateways also being coupled to the communications network. In order to realise NVOD, multiple streams of the originating data are generated by the content providing server for onward transmission to be gateways: each stream is identical to other streams generated by the content providing server, but staggered in time, i.e. contain a time delay between streams of the data. Each stream generated by the content providing server is transmitted to each of the number of gateways for broadcast to respective client units, for example, set-top boxes, i.e. decoders, coupled to respective television sets.

An alternative Known NVOD system comprises the content: providing server, coupled to the communications network in order to be able to deliver the originating data stream to the number of gateway, of the respective home networks, the number of gateways also being coupled to shin communications network. In order to realise NVOD, the multiple streams of the originating data are generated by the content providing server for onward transmission to the gateways, each stream again being identical to the other streams generated by the content providing server, but staggered in time. Each data stream is transmitted to a multicast server attached to the communications network. The multicast server transmits the multiple streams received from the content providing server to each of The number of gateways. In this example, a number of multicast servers capable of communicating with the content providing server are usually provided. In order to reduce bandwidth requirements, each of the number of multicast servers is disposed as close as possible to gateways being serviced by the multicast server.

Both of the above described NVOD systems require a relatively large bandwidth to be provided for communications between, in the first example, the content providing server and the number of the gateways, and in the second example, between the content providing server and the multicast servers. With increased demands for distribution services and the existence of the limited bandwidth mentioned-above, it is anticipates that the above NVOD techniques will not be able to cope with envisaged volumes of traffic.

### SUMMARY OF THE INVENTION

According to a first aspect of the invention, there is provided a system for streaming data comprising a content providing server capable of storing content and communicating the content to at least a first and a second recipient servers via a communications network, and a distribution server coupled in-line between the content providing server and the at least the first and second recipient servers, wherein the distribution server is arranged to generate at least a first and a second onward data streams and transmit the at least the first and second onward data streams to the at least the first and second recipient servers, respectively, in response to an incoming data stream received from the content providing server and corresponding to the content, wherein the at least the first and second onward data streams correspond substantially to the content and are offset in time with respect to each other by a respective offset value.

Preferably the first and/or the second onward data streams are generated prior to receipt of ail of the incoming data stream.

Preferably, the offset value is provided by the content providing server.

Preferably, the distribution server is arranged to loop the first onward data stream at least once.

According to a second aspect of the invention, there is provided a multicast server for streaming data, comprising a processor unit coupled to a storage device and a router, the processor unit being arranged to receive an incoming data stream corresponding to content and storing the content in the storage device, wherein the processor unit is further arranged to generate at least a first and a second onward data streams for transmission to at least a first and a second recipient servers, respectively, in response to tie incoming data stream, wherein the at least the first and second onward data streams correspond substantially to the content and are offset in time with respect to each other by a respective offset value.

Preferably, the router is arranged to transmit the at least the first and the second onward data streams to the at least the first and the second recipient servers, respectively.

Preferably, the first and/or the second onward data streams are generated prior to receipt of all of the incoming data stream.

Preferably, the offset value is provided by a content providing server.

Preferably, the processor unit is arranged to loop the first onward data stream at least once;

According to a third aspect of the invention, there, is provided a method of streaming data between a content providing server and at least a first, and a second recipient servers, the method comprising the steps of: receiving an incoming data stream corresponding to content; generating at least a first and a second onward data streams; transmitting the at least the first and second onward data streams to the at least the first and second recipient servers respectively, in response to the incoming data stream; wherein the at least the first and second onward data streams correspond substantially to the content and are offset in time with respect to each other by a respective offset value.

Preferably, the method further comprises generating the at least first and/or the second onward data streams prior to receipt of all of the incoming data stream.

Preferably, the method further comprises the content providing server providing the offset value.

Preferably, the method further comprises the step of looping the first onward data stream at least once.

According to a fourth aspect of the invention, there is provide computer executable software code stored on a computer readable medium, the code being for streaming data between a content providing server and at least a first and a second recipient servers, the code comprising: cane to receive an incoming data stream corresponding to content, code to generate at least a first and a second onward data streams; code to transmit the at least the first and second onward data streams to the at least the first and second recipient servers, respectively, in response to the incoming data stream; wherein the at least the first and second onward data streams correspond substantially to the content and are offset in time with respect to each other by a respective offset value.

Preferably the code further comprises: code to generate the at least first and/or the second onward data streams prior to receipt of all of the incoming data stream.

Preferably, the code further comprises; code to enable the content providing server to provide the offset value.

Preferably, the code further comprises, code to loop the first onward data stream at least once.

According to a sixth aspect of the present invention, there is provided a programmed computer for streaming data between a content providing server and at least a first and a second recipient servers, comprising memory having at least one region for storing computer executable program code, and a processor for executing the program code stored in memory, wherein the program code includes: code to receive an incoming data stream corresponding to content, code to generate at least a first and a second onward data streams; code to transmit the at least the first and second onward data streams to the at least the first and second recipient servers, respectively, in response to the incoming data stream, wherein the at least the first and second onward data streams correspond substantially to the content and are offset in time with respect to each other by a respective offset value.

Preferably, the program code further comprises: code to generate the at least first and/or the second onward data streams prior to receipt of all of the incoming data stream.

Preferably, the program code further comprises: code to enable the content providing server to provide the offset value.

Preferably, the code further comprises: code to loop the first onward data stream at least once.

According to a sixth aspect of the present invention, there is provided a computer readable medium having computer executable software code stored thereon, the code being for streaming data between a content providing server and at least a first and a second recipient servers and comprising: code to receive an incoming data stream corresponding to content code to generate at least a first and a second onward data streams; code to transmit the at least the first and second onward data streams to the at least the first, and second recipient servers respectively, in response to the incoming data stream wherein the at least the first and second onward data steams correspond substantially to the content and are offset in time with respect to each other by a respective offset value.

Preferably, the code further comprises; code to generate the at least first and/or the second onward data streams prior to receipt of all of the incoming data stream.

Preferably, the code further comprises: code to enable the content providing server to provide the offset value.

Preferably, the code further comprises: code to loop the first onward data stream at least once.

It is thus possible to provide a communications system and method therefor capable of separating the generation of the data stream from the distribution of the data stream in the time-staggered form. The above-mentioned separation allows content provider overheads to be reduced, if required, by offloading the task of distribution of content to a third party. Additionally the volume of traffic carried over the communications network is reduced by the distribution of the content taking place relatively close to destinations of the content.

### BRIEF DESCRIPTION OF THE DRAWINGS

At least one embodiment of the invention will now be described, by way of example only, with reference to the accompanying drawings, in which:

FIG. 1 is a schematic diagram of a communications system constituting an embodiment of the present invention;

FIG. 2 is a schematic diagram of a content providing server of FIG. 1

FIG. 3 is a schematic diagram of a multicast server of FIG. 1;

FIG. 4 is a flow diagram relating to the operation of the content providing server of FIG. 2;

FIG. 5 is a flow diagram relating to the operation of the multicast server of FIG. 3, and

FIG. 6 is a flow diagram relating to a request for a data stream for use in the system of FIG. 1.

### PREFERRED EMBODIMENT(S) OF THE INVENTION

Throughout the following description identical reference numerals will be used to identify like parts.

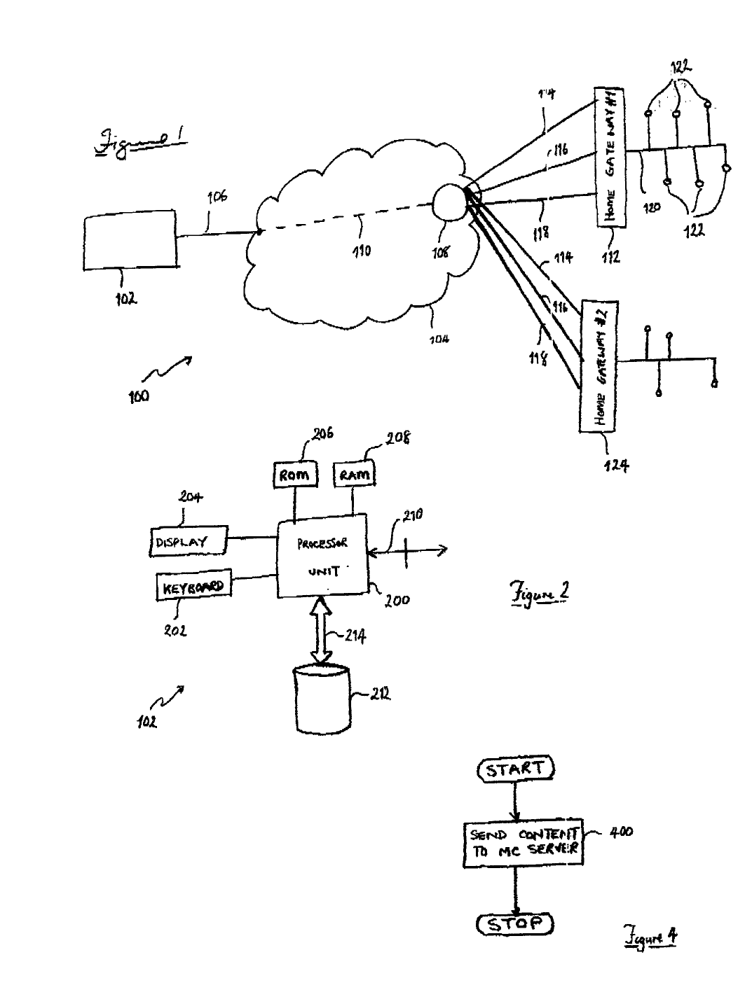

Referring to FIG. 1, a communications system 100 is capable of providing an NVOD service. To a subscriber to the NVOD service, the NVOD service is, in this example, the provision of a data stream corresponding to content, for example media, such as a cinematographic film, that repeatedly begins after a predetermined period of time, the predetermined period of time being determined by a content provider according to any appropriate criteria, for example, cost of multiple transmissions or copyright licenses.

The NVOD service is therefore the provision of a number of data streams corresponding to substantially the same content, initiation of transmission of each data stream being separated by a temporal offset. The provision of the number of data streams separated by the temporal offset is sometimes known as “staggering” the data streams.

The system 100 comprises a content providing server 102 coupled to a communications network 104 via a communications link 106. The communications network 104 is, in this example, a packet network operating in accordance with version 4 of the Internet Protocol (IPv4) However the communications network 104 can be arranged to operate accordance with other, higher, versions of the Internet Protocol, for example, IPv6.

A multicast server 108 is attached to the communications network 104 and is capable of establishing a route 110 for communicating with the content providing server 102.

The multicast server 108 is capable of communicating with a first home gateway 112 and a second home gateway 124 by directing a first data stream 114, a second data stream 116 and a third data stream 118, for example by routing, to both the first home gateway 112 and the second home gateway 124. The first home gateway 112 is coupled to a Local Area Network (LAN) 120 comprising a plurality of client terminator units 122. The LAN 120 and the client terminator units 122 constituting a subnet, i.e. each of the plurality of client terminator units 122 receives the same data as other client terminator units, coupled to the LAN 120. Similarly, the second home gateway 124 is also coupled to a respective subnet 126.

Referring to FIG. 2, the content providing server 102 comprises a processor unit 200 coupled to a content server keyboard 202 constituting a first content server input device. The processor unit 200 of the content providing server 102 is also coupled to a content server display 204 constituting a content server output device. A non-volatile storage medium, for example a Read Only Memory (ROM) 206, and a volatile storage medium, for example, a Random Access Memory (RAM) 208 are coupled to the processor unit 200 of the content providing server 102. A content server input/output interface 210 is also coupled to the processor unit 200 of the content providing server 102 in order to provide access to the communications link 106r A storage device constituting a content server cache 212 is coupled to the processor unit 200 of the content providing server 102 via a content server data bus 214. The content server cache 212 is provided for storing digital representations of content destined for the first home gateway 122 and the second home gateway 124. In this example, the content server cache 212 is a disk drive. However, it should be appreciated that other types of storage medium are also appropriate, for example solid state devices, the provision of which can result in reduced chances of mechanical failure as can occur with disk drives.

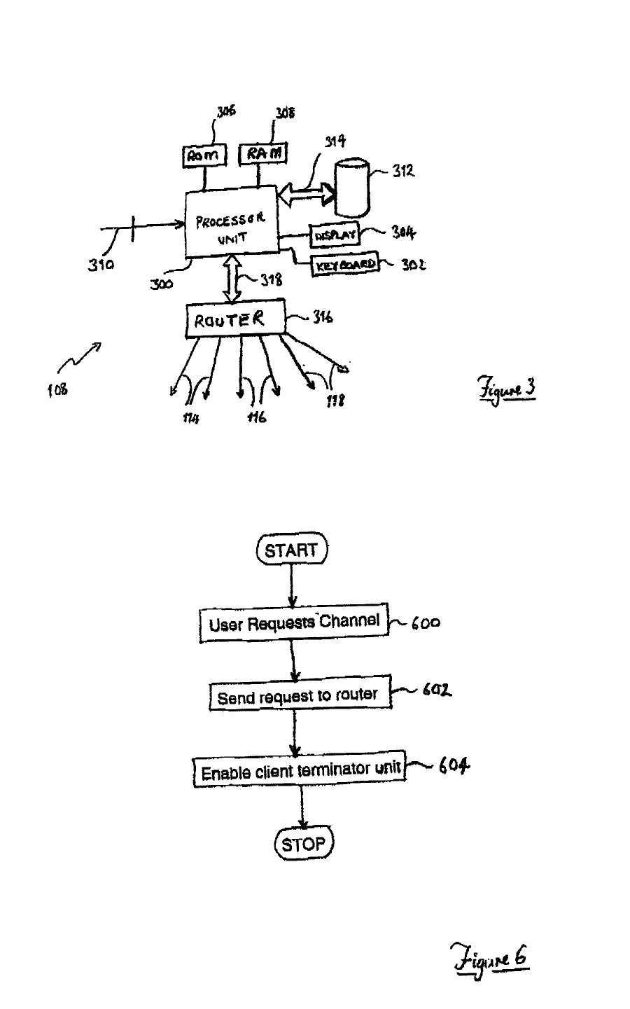

Referring to FIG. 3, the multicast server 108 comprises a processor unit 300 coupled to a multicast server keyboard 302 constituting a multicast server input device. Similarly, a multicast server display 304 is coupled to the processor unit 300 of the multicast server 108, the multicast server display 304 constituting a multicast server output device. The processor unit 300 of the multicast server 108 is coupled to a non-volatile storage medium, for example a ROM 306 and a volatile memory medium, for example a RAM 308. A multicast server input/output interface 310 is coupled to the processor unit 300 of the multicast server 108 in order to enable the multicast server 108 to communicate with the content providing server 102. A multicast server cache 312 is coupled to the processor unit 300 of the multicast server 108 via a first multicast server data bus 314, the processor unit 300 of the multicast server 108 being coupled to a router 316 via a second multicast server data bus 318. The router 316 has both buffering and multicast capabilities and is capable of providing multiple copies of the first data stream 114, the second data stream 116 and the third data stream 118.

In this example, the multicast server cache 312 is also a disk drive, but can be any other type of storage device known in the art, for example, a solid state, device. Where the multicast server cache 312 is the disk drive, the disk drive is capable of interleaved reading by means of multiple read/write heads. interleaved reading can also be achieved by spreading the content over a number of storage devices. Alternatively, the same content can be stored on a number of storage devices. Additionally, the content can be interleaved on the storage devices to enhance access performance and/or increase the number of data streams that can be provided.

In operation (FIG. 4), the content providing server 102 retrieves the content in the form of an originating data stream and transmits (step 400) the originating data stream via the communications link 106 and the route 110 to the multicast server 108. In addition to the originating data stream the content providing server 102 also transmits control data to the multicast server 108, the control data being obtained from the RAM 208, the content server cache 212 or via user input through the content server keyboard 202. The control data comprises information relating to the NVOD, for example the predetermined period of Time and a number of time delayed versions of the content to be generated. In addition, the control data can include an instruction to the multicast server 108 to loop the content for a number of times dictated by, for example, the content provider. Alternatively, the instruction can be to continually loop the content.

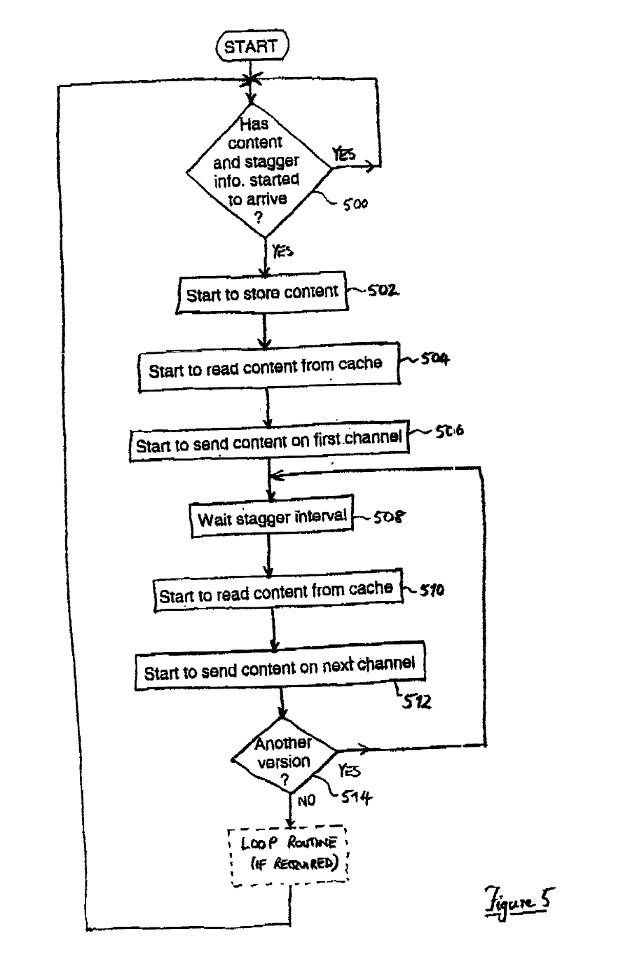

Referring to FIG. 5, the multicast server 108 awaits (step 500), the control data from the content providing server 102 in order to obtain the predetermined period of time relating to the stagger. As the originating data stream, that follows the control data, is received, the originating data stream is stored by the multicast server cache 312. Once the multicast server 108 has started storing the originating data stream (step 502) in the multicast sever cache 312, i.e. the processor unit 300 of the multicast server 108 can begin to read (step 504) the originating data stream stored in the multicast server cache 312, i.e. the processor unit 300 of the multicast server 108 does not have to wait for the whole of the originating data stream to be stored in the multicast server cache 312 before reading the originating data stream.

Consequently, the processor unit 300 of the multicast server 108 then reads (step 504) the content stored in the multicast server cache 312 and transfers the content in the form of the first data stream 114 to the router 316 via the second multicast server data bus 318. The router 316 the distributes (step 506), i.e. multicasts, the first data stream 114 to the first home gateway 112 and the second home gateway 124. The processor unit 300 of the multicast server 108 then waits (step 508) for the predetermined period of time and then re-reads (step 510) the content from the multicast server cache 312 and transfers the content to the router 316 via the second multicast server data bus 318 in the form of the second data stream 116. The router 316 then distributes (step 512), i.e. multicasts, the second data stream 116 to the first home gateway 112 and the second home gateway 124 whilst still transmitting the first data stream 114.

Based upon the control data provided by the content providing server 102, the processor unit 300 of the multicast server 108 determines (step 514) whether further staggered versions of the content need to be multicast, i.e. using the number of time delayed versions of the content information. If further staggered versions of the content need to be multicast, the processor unit 300 and the router 316 of the multicast server 108 repeat the above described steps of waiting for the predetermined period of time, reading the content from the multicast server cache 312 and distributing data stream to the first home gateway 112 and the second home gateway 124 (step 506, 508 and 510). If, however, no further staggered versions of the content are to be distributed to the first home gateway 112 and the second home gateway 124, the processor unit 300 of the multicast server 108 executes a looping routing designed to provide the looping, i.e. repeating, of content as already described above Once the looping route has been executed, the multicast server 108 freverts to waiting (step 500) for more control data relating to a further originating data stream.

Although, in the above described example, the content providing server 102 determines the predetermined period of time, the predetermined period of time can be provided from elsewhere in the communications; system 100, for example, at the multicast server 108.

Referring to FIG. 6, where a subscriber associated with a client terminator unit of the plurality of client terminator unit 122 wishes to view a channel corresponding to one of the first, second or third data streams 114, 116, 118, the subscriber selects (step 600) the channel by means of a suitable interaction with the client terminator unit. The client terminator unit then transmits (step 602) a first request to the router 316. If the multicast server 108 does not possess the requested content, the multicast server 108 forwards a second request, in a different format to the first request, to the content providing server 102. The client terminator unit is then enabled (step 604) to decrypt one of, the first, second or third data stream 114, 116, 118 (depending upon the selection made by the subscriber) so that the subscriber can view the content provided on the channel. The enablement of the client terminator unit is in accordance with any technique known in the art. The enablement of the client terminator unit also results in the first home gateway 112, to which the client terminator unit is attached, to be included in a multicast group.

The request transmitted by the client terminator unit to the router 316 of the multicast server 108 employs an Internet Group Management Protocol (IGMP). In addition, other protocols are employed between the router and the content providing server, via any intervening routers (not shown), for example a Distance Vector Multicast Routing Protocol (DVMRP). Additionally, in order to preserve bandwidth, the processor unit 300 of the multicast server 108, in this example, is arranged to only distribute the first, second an/or third data streams 114, 116, 118 to the first home gateway 112 and the second home gateway 124 once at least one of the first or second home gateway 112, 124 has joined the multicast group.

Although the above described example refers to communications in a digital domain, it should be appreciated that communications between the content providing server 102 and the multicast server 108, and/or communications between the content providing server 108 and the first home gateway 112 and/or the second home gateway 124 can be in all analog domain. Additionally, instead of, or in addition to, using the Internet Protocol for communications between the content providing server 102, and the multicast server 108 and/or between the multicast server 108 and the first home gateway 112 and/or the second home gateway 124, the content can be transferred using an Asynchronous Transmission Mode communications technique

It should be appreciated that the client terminator unit can be any terminating unit suitable for operation with the communications system 100, for example a set-top box, i.e. a cable television decoder or a Personal Computer (PC).

Alternative embodiments of the invention can be implemented as a computer program product for use with a computer system, the computer program product being, for example, a series of computer instructions stored on a tangible data recording medium, such as a diskette. CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device.

1. A system for streaming data comprising a content providing server capable of storing content and communicating the content to at least a first and a second recipient servers via a communications network and a distribution server coupled in-line between the content providing server end the at least the first and second recipient servers, wherein the distribution server is arranged to generate at least a first and a second onward data streams and transmit the at least the first and second onward data streams to the at least the first and second recipient servers, respectively, in response to an incoming data stream received from the content providing server and corresponding to the content, wherein the at least the first and second onward data streams correspond substantially to the content and are offset in time with respect to each other by a respective offset value.

2. A system as claimed in claim 1, wherein the first and/or the second onward data streams are generated prior to receipt of all of the incoming data stream.

3. A system as claimed in claim 1, wherein the offset value is provided by the content providing server.

4. A system as claimed in claim 1, wherein the distribution server is arranged to loop the first onward data stream at least once.

5. A multicast server for streaming data, comprising a processor unit coupled to a storage device and a router, the processor unit being arranged to receive an incoming data stream corresponding to content and storing the content in the storage device, wherein the processor unit is further arranged to generate at least a first and a second onward data stream for transmission to at least a first and a second recipient servers, respectively, in response to the incoming data stream, wherein the at least the first and second onward data streams correspond substantially to the content and are offset in time with respect to each other by a respective offset value.

6. A multicast server as claimed in claim 5, wherein the router is arranged to transmit the at least the first and the second onward data streams to the at least the first and the second recipient servers, respectively.

7. A multicast server as claimed in claim 5, wherein the first and/or the second onward data streams are generated prior to receipt of all of the incoming data stream.

8. A multicast server as claimed in claim 5, wherein the offset value is provided by a content providing server.

9. A multicast server as claimed in claim 5, wherein the processor unit is arranged to loop the first onward data stream at least once.

10. A method of streaming data between a content providing server and at least a first and a second recipient servers, the method comprising the steps of:
receiving an incoming data stream corresponding to content,
generating at least a first and a second onward data streams;
transmitting the at least the first and second onward data streams to the at least the first and second recipient servers, respectively, in response to the incoming data stream;
wherein the at least the first and second onward data streams correspond substantially to the content and are offset in time with respect to each other by a respective offset value.

11. A method as claimed in claim 11, further comprising generating the at least first and/or the second onward data streams prior to receipt of all of the incoming data stream.

12. A method as claimed in claim 11, further comprising the content providing server providing the offset value.

13. A method as claimed in claim 11, further comprising the step of looping the first onward data stream at least once.

14. Computer executable software code stored on a computer readable medium, the code being for streaming data between a content providing server and at least a first and a second recipient servers, the code comprising:
code to receive an incoming data stream corresponding to content,
code to generate at least a first and a second onward data streams,
code to transmit the at least the first and second onward data streams to the at least the first and second recipient servers, respectively, in response, to the incoming data stream;
wherein the at least the first and second onward data streams correspond substantially to the content and are offset in time with respect to each other by a respective offset value.

15. Computer executable software code as claimed in claim 14, further comprising:
code to generate the at least first and/or the second onward data streams prior to receipt of all of the incoming data stream.

16. Computer executable software code as claimed in claim 14, further comprising:
code to enable the content providing server to provide the offset value.

17. Computer executable software code as claimed in claim 14, further comprising:
code to loop the first onward data stream at least once.

18. A programmed computer for streaming data between a content providing server and at least a first and a second recipient servers, comprising memory having at least one region for storing computer executable program code, and
a processor for executing the program code stored in memory, wherein the program code includes:
code to receive an incoming data stream corresponding to content
code to generate at least a first and a second onward data streams;
code to transmit the at least the first and second onward data streams to the at least the first and second recipient servers, respectively, in response to the incoming data stream;
wherein the at least the first and second onward data streams correspond substantially to the content and are offset in time with respect to each other by a respective offset value.

19. A programmed computer as claimed in claim 18, wherein the program code further comprises:
code to generate the at least first and/or the second onward data streams prior to receipt of all of the incoming data stream.

20. A programmed computer as claimed in claim 18, wherein the program code further comprises:
code to enable the content providing server to provide the offset value.

21. A programmed computer as claimed in claim 18, wherein the program code further comprises:
code to loop the first onward data stream at least once.

22. A computer readable medium having computer executable software code stored thereon, the code being for streaming data between a content providing server and at least a first and a second recipient servers and comprising:
code to receive an incoming data stream corresponding to content,
code to generate at least a first and a second onward data streams;
code to transmit the at least the first and second onward data streams to the at least the first and second recipient servers, respectively, in response to the incoming data stream;
wherein the at least the first and second onward data streams correspond substantially to the content and are offset in time with respect to each other by a respective offset value.

23. A computer readable medium as claimed in claim 22, further comprising:
code to generate the at least first and/or the second onward data streams prior to receipt of all of the incoming data stream.

24. A computer readable medium as claimed in claim 22, further comprising:
code to enable the content providing server to provide the offset value.

25. A computer readable medium as claimed in claim 22, further comprising:
code to loop the first onward data stream at least once.
